(19) United States
(12) Patent Application Publication
(10) Pub. No.: US 2008/0020257 A1
(43) Pub. Date: Jan. 24, 2008

(54) FUEL CELL DEVICE WITH ELECTRONIC IDENTIFICATION

(76) Inventors: HSI-MING SHU, Taipei (TW); Wei-Li Huang, Taipei (TW)

Correspondence Address: G. LINK CO., LTD., 3550 BELL ROAD, MINOOKA, IL, 60447, US

(21) Appl. No.: 11/459,017

(22) Filed: Jul. 20, 2006

(51) Int. Cl. H01M 8/24; H01M 8/10; H01M 8/04

(52) U.S. Cl. 429/34; 429/22; 429/30; 429/32

(57) ABSTRACT

A fuel cell device with an identification device is described, which comprises a fuel cell board and a memory device. The fuel cell board includes at least one or more printed circuit substrates laminated and sealed into a single layer. At least one membrane electrode assembly is disposed between the printed circuit substrates. An electrical interface is disposed on the fuel cell board for transmitting electrical signals of the fuel cell board. The memory device is used for recording identification data of the fuel cell board, and is disposed directly on the fuel cell board or on an externally-connected interface coupled to the fuel cell board through the electrical interface.

### FIELD OF THE INVENTION

The present invention relates to a device of a fuel cell, and more particularly, to a fuel cell device having a mechanism for identifying data.

### BACKGROUND OF THE INVENTION

Conventional fuel cells usually use redox of hydrogen-containing fuels like methanol to generate current loops and supply power. Such fuel cells require reactants including liquid fuels, such as methanol, and produce products including water and carbon dioxide after performing reactions. Hence, this kind of fuel cell needs a container for containing liquid fuels and a flow structure for flowing fuels.

However, conventional fuel cells do not possess a mechanism for externally providing data, and thus it is difficult for an outer electronic device to get information about the specifications of fuel cells automatically. Additionally, in view of the trend towards systemized fuel cells and access service provided by fuel cell suppliers, an outer electronic device needs to automatically identify the specifications or other particular information of fuel cells.

Therefore, a fuel cell having an identification device is needed to meet the aforesaid requirements.

### SUMMARY OF THE INVENTION

It is a primary object of the invention to provide a fuel cell device with an identification device that is capable of providing information externally, so it is more convenient and accurate to select components to assemble fuel cells.

In accordance with the aforesaid objects of the invention, a fuel cell device with an identification device is provided, which comprises a fuel cell board and a memory device. The fuel cell board includes at least one or more printed circuit substrates laminated and sealed into a single layer. At least one membrane electrode assembly is disposed between the printed circuit substrates. An electrical interface is disposed on the fuel cell board for transmitting electrical signals from the fuel cell board. The memory device is used to record identification data of the fuel cell board, and is disposed directly on the fuel cell board or on an externally-connected interface coupled to the fuel cell board through the electrical interface.

### BRIEF DESCRIPTION OF THE DRAWINGS

The above objects and advantages of the present invention will become more apparent with reference to the appended drawings wherein:

FIG. 1 shows the plan view of a fuel cell device with an identification device according to the first embodiment of the invention; and

FIG. 2 shows the plan view of a fuel cell device with an identification device according to the second embodiment of the invention.

### DETAILED DESCRIPTION OF THE INVENTION

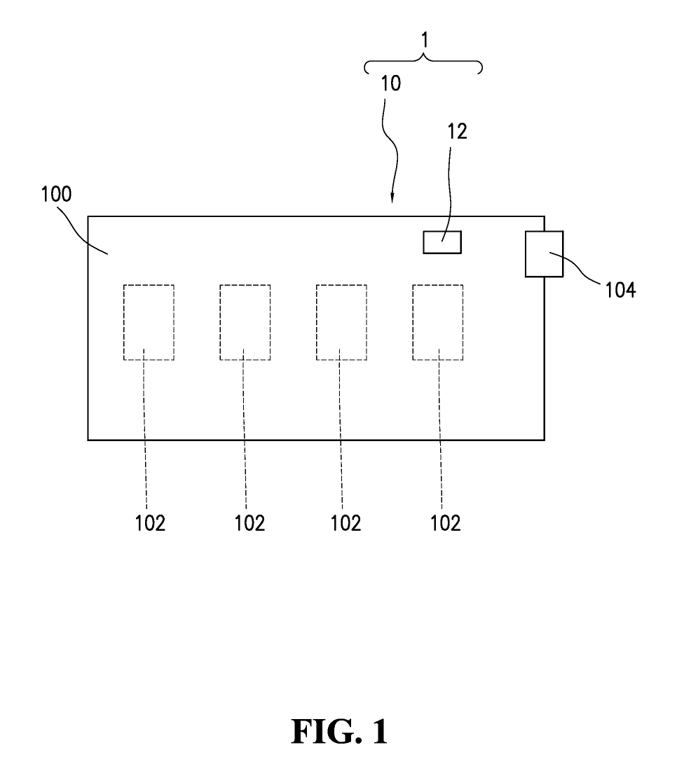

FIG. 1 shows the plan view of a fuel cell device with an identification device according to the first embodiment of the invention. The fuel cell device 1 with an electronic identification includes a fuel cell board 10 and a memory device 12. The fuel cell board 10 is composed of at least one or more printed circuit substrates 100, which are laminated and sealed into a single layer. At least one membrane electrode assembly (MEA) 102 is disposed between the stacked substrates 100. The most outer substrate 100 of the fuel cell board 10 includes an electrical interface 104. The memory device 12 is deployed directly onto the fuel cell board 10; for example, the memory device 12 is soldered on the most outer substrate 100 of the fuel cell board 10, or the memory device 12 is sandwiched in between the substrates 100.

The printed circuit substrate 100 may adopt a FR4 substrate, an epoxy resin substrate, a glass fiber substrate, a ceramic substrate, a polymeric plastic substrate, or a composite substrate. The memory device 12 is provided to record the identification data of the fuel cell board 10. The memory device 12 serves as an electronic label for the fuel cell board 10. An exemplar of the memory device 12 may be a semiconductor memory, such as a non-volatile memory like erasable programmable read only memory (EPROM), electrically erasable programmable read only memory (EEPROM), and flash memory. Or, the memory device 12 may include both non-volatile memory and volatile memory. Volatile memories may be dynamic random access memories (DRAM) and static random access memories (SRAM). Alternatively, the memory device 12 may be a controller with a built-in memory component.

The identification data may include, for example, power of a single MEA, types of fuels, required specifications, production records, factory data, specifications of peripherals, and so on. Those illustrations are merely exemplary, and not intended to limit the scope of the identification data. Because the fuel cell device 1 possesses the mechanism for identifying data, an external device can know the specifications of the fuel cell board 10 well via the mechanism of identifying data, and also select other elements with proper specifications via the mechanism for identifying data, such as adequate types of fuels, or types and specifications of equipment that is suitable for the fuel cell board 10.

Aside from the aforementioned identification data, the memory device 12 stores event data occurring during the operation of a fuel cell board. The event data may include, for example, present output voltage, present output current, present temperature, operational time, and present fuel concentration, and so forth. Those illustrations are merely exemplary, and not intended to limit the scope of the event data.

The electrical interface 104 is used to connect an external device with the fuel cell board 10, and to transmit electrical signals corresponding to the identification data and the event data. The fuel cell board 10 may transmit data outward or exchange data in duplex through the electrical interface 104. The electrical interface 104 may adopt a universal serial bus (USB) interface, IEEE 1394 interface, SDIO interface, Bluetooth interface, RS-232 interface, RU-486 interface, infrared transmission interface, RF communication interface, or combination thereof. The electrical interface 104 may be connected by, for example, a connector or a gold finger.

According to an example of the fuel cell device 1 of the invention, due to the identification mechanism of the fuel cell device 1, as the fuel cell board 10 is connected to a notebook computer through a USB interface 104, the fuel cell device 1 supplies power for the operation of the notebook computer, and the notebook computer reads the identification data and event data from the memory device 12, such that the notebook computer manages electricity more precisely to extend its working duration.

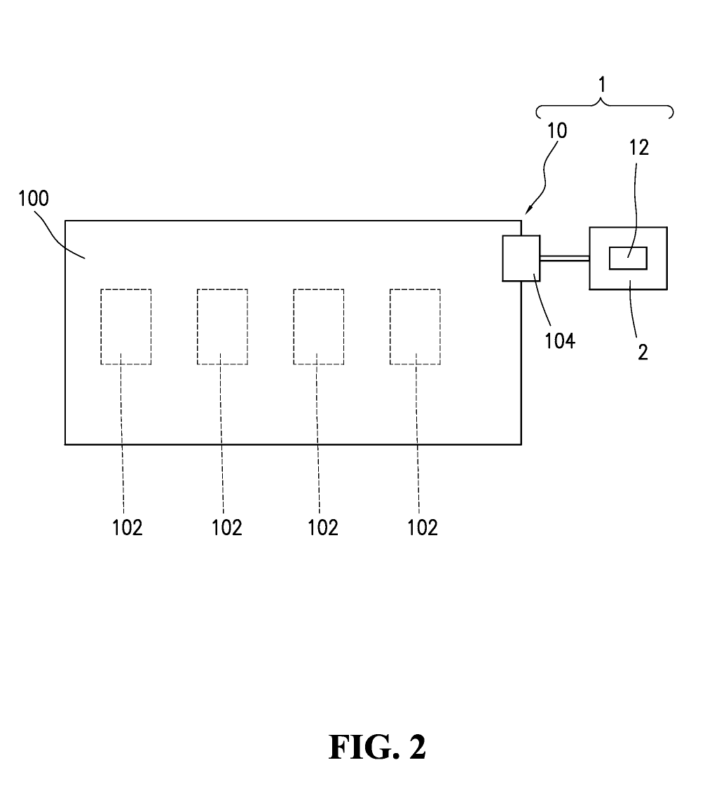

FIG. 2 shows the plan view of a fuel cell device with an identification device according to the second embodiment of the invention. The difference between the second and the first embodiments consists in the memory device 12 disposed in an externally-connected interface 2. The externally-connected interface 2 is coupled to the fuel cell board 10 through the electrical interface 104. The externally-connected interface 2 may be a piece of printed circuit board, and the memory device 12 is soldered on the printed circuit board.

In the second embodiment, the printed circuit board 2 may be used as an additional externally-connected board for the fuel cell board 10. Accordingly, the additional externally-connected board may be applied to various fuel cell boards 10 after the memory device 12 of the printed circuit board 2 stores corresponding identification data regarding fuel cell boards 10 with different specifications.

A fuel cell device with an electronic identification mechanism can perform the function of identifying data, and hence it may raise its own value. Also, the fuel cell device is capable of providing information externally, and thus it is more convenient and accurate to select components to assemble the fuel cell device.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel cell device with an identification device, the fuel cell device comprising:
a fuel cell board, comprising:
at least one or more printed circuit substrates, wherein the printed circuit substrates are laminated and sealed into a single layer;
at least one membrane electrode assembly disposed between the printed circuit substrates; and
an electrical interface disposed on the fuel cell board for transmitting electrical signals of the fuel cell board; and
a memory device for recording identification data of the fuel cell board, wherein the memory device is disposed directly onto the fuel cell board, or is disposed within an externally-connected interface, and the externally-connected interface is coupled to the fuel cell board through the electrical interface.

2. The fuel cell device of claim 1, wherein the printed circuit substrate is a FR4 substrate, an epoxy resin substrate, a glass fiber substrate, a ceramic substrate, a polymeric plastic substrate, or a composite substrate thereof.

3. The fuel cell device of claim 1, wherein the memory device is a semiconductor memory.

4. The fuel cell device of claim 1, wherein the identification data comprises power of a single membrane electrode assembly and/or types of fuels and/or required specifications and/or production records and/or factory data and/or specifications of peripherals.

5. The fuel cell device of claim 1, wherein the electrical interface is a USB interface, an IEEE 1394 interface, an SDIO interface, a Bluetooth interface, an RS-232 interface, an RU-486 interface, an infrared transmission interface, or an RF communication interface.

6. The fuel cell device of claim 1, wherein the memory device is soldered on the fuel cell board.

7. The fuel cell device of claim 6, wherein the memory device is sandwiched in between the printed circuit substrates.

8. The fuel cell device of claim 1, wherein the memory device further records event data occurring during operation of the fuel cell board.

9. The fuel cell device of claim 8, wherein the event data comprises present output voltage and/or present output current and/or present temperature and/or operational time and/or present fuel concentration.

10. The fuel cell device of claim 1, wherein the memory device is a controller with a built-in memory component.

11. The fuel cell device of claim 1, wherein the externally-connected interface is a printed circuit board, and the printed circuit board comprises the memory device.

12. The fuel cell device of claim 1, wherein the electrical interface transmits electrical signals corresponding to the identification data.

13. The fuel cell device of claim 8, wherein the electrical interface transmits electrical signals corresponding to the event data.

14. The fuel cell device of claim 1, wherein the electrical interface comprises a connector.

15. The fuel cell device of claim 1, wherein the electrical interface comprises a gold finger.
